(19) United States
(12) Patent Application Publication
(10) Pub. No.: US 2003/0108403 A1
(43) Pub. Date: Jun. 12, 2003

(54) Fluid flow bolt system

(76) Inventor: James E. Van Scoyoc, Holly, MI (US)

Correspondence Address: Michael S. Neustel, Suite No. 4, 2534 South University Drive, Fargo, ND, 58103, US

(21) Appl. No.: 10/017,041

(22) Filed: Dec. 12, 2001

(51) Int. Cl. F16B 35/04

(52) U.S. Cl. 411/421

(57) ABSTRACT

A fluid flow bolt system for allowing fluid to flow about a threaded fastener when secured within a component. The fluid flow bolt system includes a solid shaft having an inner end and an outer end, a head attached to the inner end of the shaft, a plurality of channels extending within the outer surface of the shaft, and threading extending into the shaft. The depth of the channels is sufficiently greater than the depth of the threading grooves to allow for the passage of fluid through the channels when the bolt is threadably secured within a component. The channels preferably have a spiral pattern to allow for clean threading of the shaft.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to fasteners and more specifically it relates to a fluid flow bolt system for allowing fluid to flow about a threaded fastener when secured within a component.

2. Description of the Prior Art

Fluid flow through bolts have been in use for years and are often times referred to a “banjo bolt”. Banjo bolts are used in applications where fluid flow about a fastener is required such as in brake calipers. A conventional fluid flow through bolt is constructed by drilling a first bore into the distal end of the bolt concentrically. The user then drills a second bore radially into the inner end of the bolt to fluidly connect to the first bore.

The main problem with conventional fluid flow through bolts is that they require an extensive amount of time to prepare. Another problem with conventional fluid flow through bolts is that connecting the first bore with the second bore can be difficult to accomplish leaving partially connected bores which do not allow adequate fluid flow. A further problem with conventional fluid flow through bolts is that metal debris remaining within the bores after the drilling may interfere with the fluid flow or damage the components intended to be lubricated.

Examples of patented devices which are related to the present invention include U.S. Pat. No. 2,409,638 to Lyon; U.S. Pat. No. 5,407,312 to Terrizzi; U.S. Pat. No. 2,913,031 to McKay et al.; U.S. Pat. No. 5,452,977 to Terrizzi; and U.S. Pat. No. 5,074,728 to Hsu.

While these devices may be suitable for the particular purpose to which they address, they are not as suitable for allowing fluid to flow about a threaded fastener when secured within a component. Conventional flow through bolts are difficult to manufacture and are susceptible to inadequate fluid flow.

In these respects, the fluid flow bolt system according to the present invention substantially departs from the conventional concepts and designs of the prior art, and in so doing provides an apparatus primarily developed for the purpose of allowing fluid to flow about a threaded fastener when secured within a component.

### SUMMARY OF THE INVENTION

In view of the foregoing disadvantages inherent in the known types of fluid flow fasteners now present in the prior art, the present invention provides a new fluid flow bolt system construction wherein the same can be utilized for allowing fluid to flow about a threaded fastener when secured within a component.

The general purpose of the present invention, which will be described subsequently in greater detail, is to provide a new fluid flow bolt system that has many of the advantages of the fluid flow fasteners mentioned heretofore and many novel features that result in a new fluid flow bolt system which is not anticipated, rendered obvious, suggested, or even implied by any of the prior art fluid flow fasteners, either alone or in any combination thereof.

To attain this, the present invention generally comprises a solid shaft having an inner end and an outer end, a head attached to the inner end of the shaft, a plurality of channels extending within the outer surface of the shaft, and threading extending into the shaft. The depth of the channels is sufficiently greater than the depth of the threading grooves to allow for the passage of fluid through the channels when the bolt is threadably secured within a component. The channels preferably have a spiral pattern to allow for clean threading of the shaft.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a fluid flow bolt system that will overcome the shortcomings of the prior art devices.

A second object is to provide a fluid flow bolt system for allowing fluid to flow about a threaded fastener when secured within a component.

Another object is to provide a fluid flow bolt system that ensures that adequate fluid flow about a bolt will occur.

An additional object is to provide a fluid flow bolt system that is simple to manufacture.

A further object is to provide a fluid flow bolt system that does not require drilling into a bolt.

Another object is to provide a fluid flow bolt system that reduces metal debris.

Another object is to provide a fluid flow bolt system that is less expensive to manufacture than conventional fluid flow through bolts.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a side view of the present invention as initially cold formed illustrating the plurality of channels having a spiral pattern.

FIG. 3 is a side view of the present invention with threading applied to the shaft about the channels.

FIG. 4 is a cross sectional view taken along line 4-4 of FIG. 2.

### DESCRIPTION OF THE PREFERRED EMBODIMENT

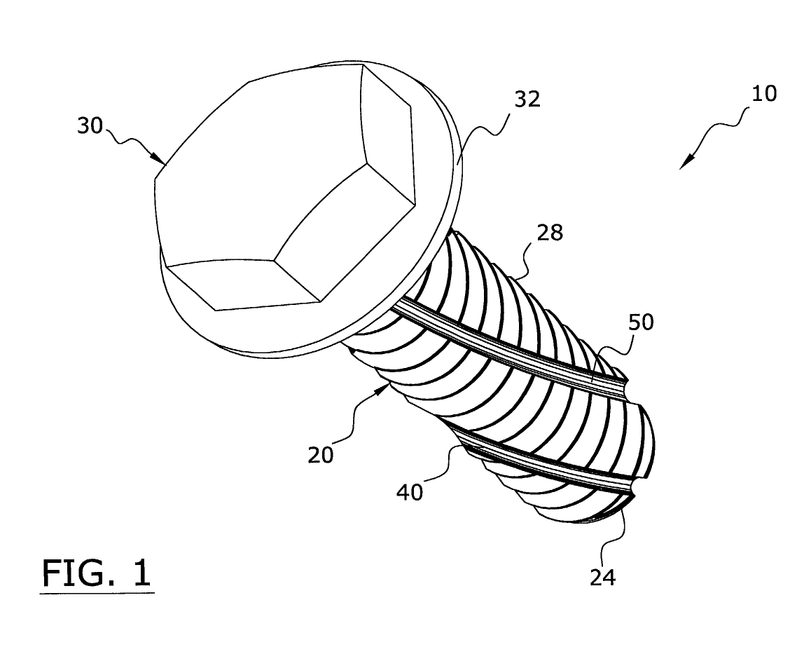

Turning now descriptively to the drawings, in which similar reference characters denote similar elements throughout the several views, FIGS. 1 through 4 illustrate a fluid flow bolt system 10, which comprises a solid shaft 20 having an inner end 22 and an outer end 24, a head 30 attached to the inner end 22 of the shaft 20, a plurality of channels 40, 50, 60 extending within the outer surface of the shaft 20, and threading extending into the shaft 20. The depth of the channels 40, 50, 60 is sufficiently greater than the depth of the threading grooves 26 to allow for the passage of fluid through the channels 40, 50, 60 when the bolt is threadably secured within a component. The channels 40, 50, 60 preferably have a spiral pattern to allow for clean threading of the shaft 20.

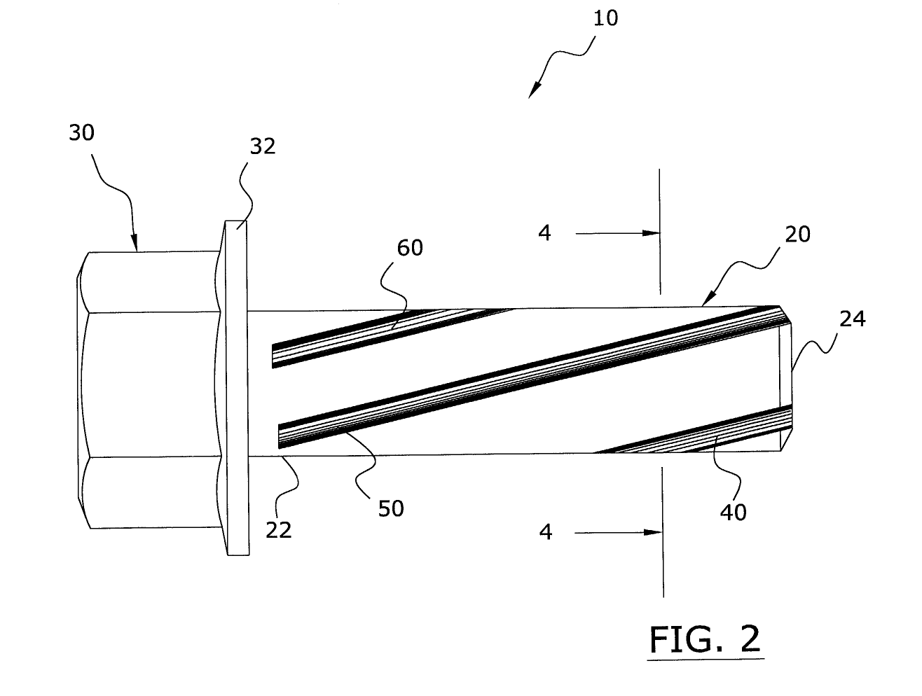

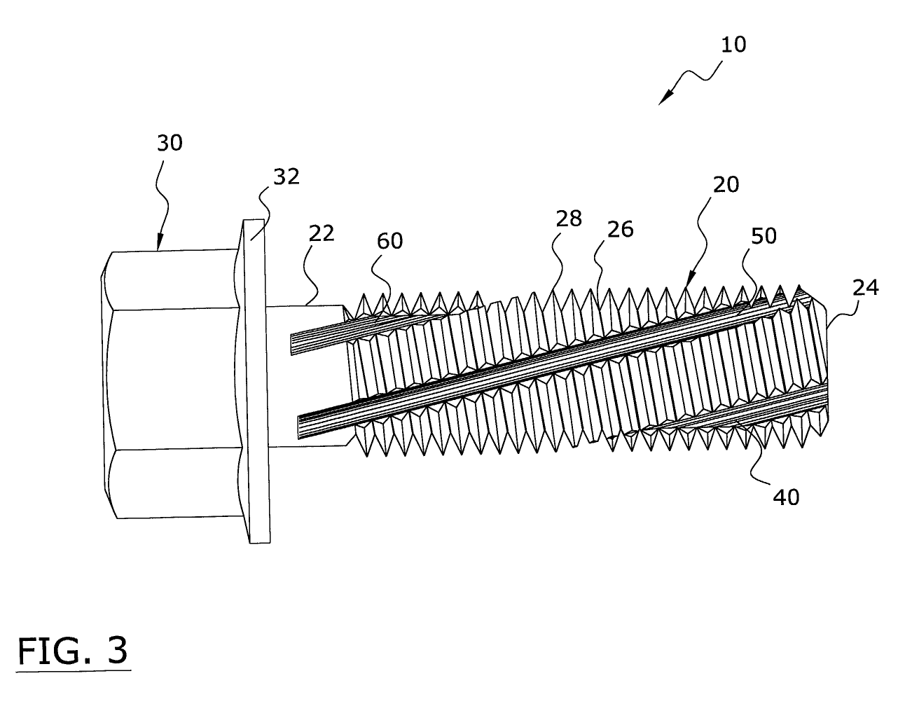

As shown in FIGS. 1 through 3 of the drawings, the present invention includes a elongate solid shaft 20 having an inner end 22, an outer end 24 and an diameter. A head 30 having a broader size than the shaft 20 is attached to the inner end 22 of the shaft 20 as best shown in FIGS. 2 and 3 of the drawings. The head 30 and the shaft 20 may be comprised of various types of rigid materials such as but not limited to SAE grade steel, alloy steel, stainless steel, brass, aluminum, plastic, composite or other types of rigid materials.

The head 30 may have various configurations which are well known with fasteners. The head 30 may have a polygonal external shape as shown in FIGS. 1 through 3 of the drawings. The head 30 may also have a polygonal cavity for receiving various types of wrenches. In addition, the head 30 may also include a flange 32 adjacent to the shaft 20 as shown in FIGS. 1 through 3 of the drawings. The attached figures should not limited the scope of the invention as applied to the structure of the head 30.

As shown in FIG. 2 of the drawings, a plurality of channels 40, 50, 60 extend relatively longitudinally into the outer portion of the shaft 20. The channels 40, 50, 60 are preferably cold formed into the shaft 20 during the forming of the shaft 20 and bead 30. The channels 40, 50, 60 are preferably parallel to one another in a spiral pattern having a specific pitch as best illustrated FIG. 2 of the drawings. The spiral pattern of the channels 40, 50, 60 is preferably angled toward the direction that a threading device rotates upon the shaft 20 to create the threading grooves 26.

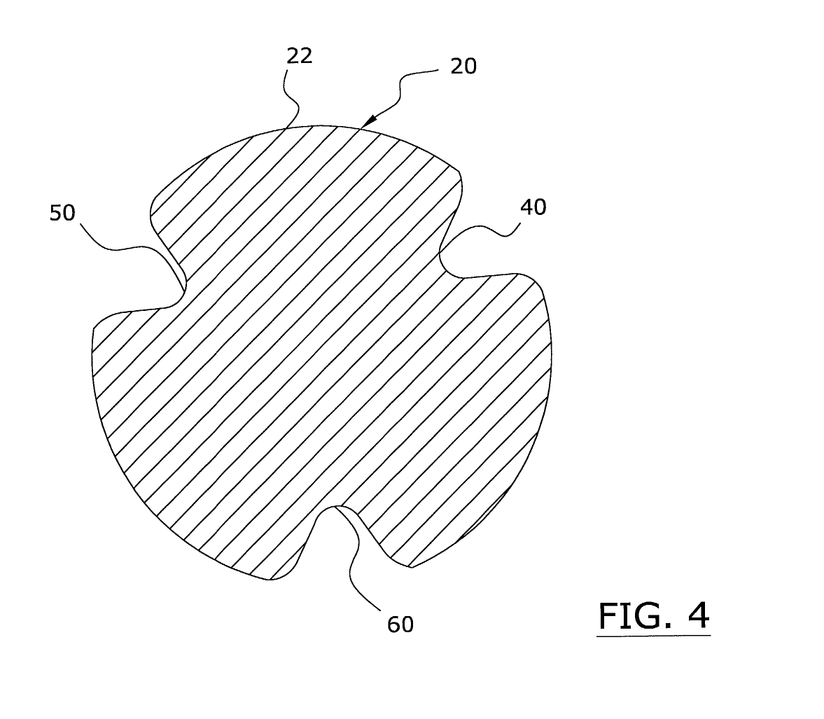

The channels 40, 50, 60 may have various depths and cross sectional shapes, however, the depth of the channels 40, 50, 60 must be greater than the depth of the threading grooves 26 of the threading to allow for sufficient fluid passage as illustrated in FIG. 3 of the drawings. The depth of the channels 40, 50, 60 may be between 1% to 200% deeper than the depth of the threading grooves 26. As shown in FIG. 4 of the drawings, the channels 40, 50, 60 have a V-shaped structure with the outer broad portion and inner narrow portion rounded to facilitate threading of the shaft.

FIGS. 1 through 4 illustrate a first channel 40, a second channel 50 and a third channel 60 positioned within the shaft 20 at approximately 120 degrees apart. The channels 40, 50, 60 are preferably equally spaced apart upon the shaft 20. If four channels are utilized, a 90 degree separation between the channels is desired. If two channels are utilized, a 180 degree separation between the channels would be used. Additional channels may be utilized and the pitch of the channels 40, 50, 60 may vary according to the desired usage and effect.

As shown in FIG. 3 of the drawings, a die threading process is applied to the shaft 20 along a desired portion of the shaft 20 from the distal end. The die threading process is comprised of a conventional threading technique involving the usage of a threading die or similar apparatus. The threading die utilizes a plurality of cutting members that cut the threading grooves 26 into the shaft 20 at a specific depth and pitch leaving a corresponding plurality of threading ridges 28 which are approximately the diameter of the shaft 20 as originally formed. The depth of the threading grooves 26 are sufficiently less than the depth of the channels 40, 50, 60 to allow for fluid to pass through the channels 40, 50, 60 when the bolt is threadably secured within a component.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fluid flow bolt, comprising:
a shaft having an elongate structure and a head;
a plurality of channels extending into an outer portion of said shaft from a distal end of said shaft having a depth D1; and
a threading within said shaft having a plurality of threading grooves having a depth D2 and threading ridges;
said depth D1 is greater than said depth D2.

2. The fluid flow bolt of claim 1, wherein said channels each have a V-shaped cross sectional shape.

3. The fluid flow bolt of claim 2, wherein said V-shaped cross sectional shape has a rounded narrow portion and rounded broad ends.

4. The fluid flow bolt of claim 1, wherein said channels are equally spaced apart within said shaft.

5. The fluid flow bolt of claim 1, wherein said channels have a spiral pattern.

6. The fluid flow bolt of claim 1, wherein said plurality of channels is comprised of a first channel, a second channel and a third channel.

7. The fluid flow bolt of claim 6, wherein said channels are positioned 120 degrees with respect to one another.

8. The fluid flow bolt of claim 7, wherein said channels each have a V-shaped cross sectional shape.

9. The fluid flow bolt of claim 1, wherein said channels extend from said distal end of said shaft to near said head.

10. The fluid flow bolt of claim 1, wherein said channels extend from said distal end of said shaft completely through said threading and away from said threading a finite distance.

11. The method of manufacturing a fluid flow bolt of claim 1, wherein said depth D1 is at least 15 percent greater than said depth D2.

12. A method of manufacturing a fluid flow bolt, comprising the steps of:
(a) providing a cold forming die;
(b) cold forming a bolt within said cold forming die having an elongate shaft, a head and a plurality of channels within said elongate shaft having a depth D1; and
(c) threading a plurality of threading grooves within said shaft having a depth D2, wherein said depth D1 is greater than said depth D2.

13. The method of manufacturing a fluid flow bolt of claim 12, wherein said plurality of channels form a spiral pattern.

14. The method of manufacturing a fluid flow bolt of claim 12, wherein said depth D1 is at least 15 percent greater than said depth D2.

15. The fluid flow bolt of claim 12, wherein said channels each have a V-shaped cross sectional shape.

16. The fluid flow bolt of claim 15, wherein said V-shaped cross sectional shape has a rounded narrow portion and rounded broad ends.

17. The fluid flow bolt of claim 12, wherein said channels are equally spaced apart within said shaft.

18. The fluid flow bolt of claim 13, wherein said channels have a spiral pattern.

19. The fluid flow bolt of claim 12, wherein said plurality of channels is comprised of a first channel, a second channel and a third channel.

20. The fluid flow bolt of claim 19, wherein said channels are positioned 120 degrees with respect to one another.
